(19) United States
(12) Patent Application Publication
(10) Pub. No.: US 2005/0052963 A1
(43) Pub. Date: Mar. 10, 2005

(54) COMPENSATOR CIRCUIT FOR AN OPTICAL STORAGE DEVICE

(76) Inventors: Li-Ting Chen, Taipei City (TW); Yi-Jen Chung, Taipei City (TW); Chi-Mou Chao, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/605,094

(22) Filed: Sep. 8, 2003

(51) Int. Cl. G11B 7/00

(52) U.S. Cl. 369/44.29; 369/44.35

(57) ABSTRACT

A compensator circuit comprises a phase-lead compensator for receiving an error signal generated by an optical storage device and generating a phase-lead error signal, a band-pass filter connected in parallel with the lead compensator for magnifying a rotating frequency error signal and generating a filtered signal, and an adder for synthesizing the phase-lead error signal and the filtered signal so as to reduce a steady-state error of the error signal. The compensator circuit does not comprise any phase-lag compensator.

### BACKGROUND OF INVENTION

1. Field of the Invention

The present invention relates to an optical storage device, and more particularly, to a compensator circuit for compensating error signals generated by the optical storage device.

2. Description of the Prior Art

An optical storage media, such as a compact disc, has the advantages of low-cost and impressive data storage capacity and has becoming one of the most popular data storage media. Consequently, a CD drive for accessing data stored in a compact disc has becoming a standard equipment of a personal computer in recent years.

A CD drive writes/reads data into/from a compact disc with a pickuphead by emitting laser beams onto the compact disc and receiving laser beams reflected from the compact disc. In order to precisely and efficiently process a great amount of data, a CD drive comprises a focus & track servo system for controlling an actuator to function stably and generating a steady-state error of a value as small as possible accordingly.

In general, the focus & track servo system of the CD drive for controlling the actuator comprises a phase-lead compensator and a phase-lag compensator. Please refer to FIG. 1, which is a Bode plot of a first-order phase-lead compensator according to the prior art. The phase-lead compensator has a frequency response of G(s)=(1+aT_{lead}s)/(1+T_{lead}ds), where a is larger than one. Since the phase-lead compensator is added to the system, and the added pole corresponding to the phase-lead compensator has a negative number smaller than that of the added zero, the phase-lead compensator contributes that an intersection of the asymptotes along the real axis in a root locus is moved further into the left half plane, and the entire root locus is shifted leftward, this increasing the region of stability as well as the response speed. The phase-lead compensator has a side effect of adding a positive phase of a value between zero and 90 degrees to the system over two corner frequencies 1/aT_{lead} and 1/T_{lead}. The phase-lead compensator will inevitably increase the total phase of the system.

Please refer to FIG. 2, which is a Bode plot of a first-order phase-lag compensator according to the prior art. The phase-lag compensator has a frequency response of G(s)=(1+aT_{lag}s)/(a*(1+T_{lag}s)), wherein a is less than one. The phase-lag compensator also has a side effect of adding a negative phase instead of a positive phase over two corner frequencies 1/T_{lag} and 1/aT_{lag}. Since the phase-lag compensator is added to the system, and the added pole/zero corresponding to the phase-lag compensator are closer to the origin than the original poles/zeros are, the phase-lag compensator causes the entire root to be shifted rightward. Although the added phase-lag compensator does not appreciably change the transient response or stability characteristics of the system, the phase-lag compensator can still improve the systems steady-state error. In contrast to the phase-lead compensator, the phase-lag compensator adds a negative phase to the system and is capable of compensating the added positive phase provided by the phase-lead compensator.

The phase-lag compensator is used to compensate a low-frequency signal. If the frequency of the signal is becoming higher than the corner frequency 1/T_{lag} (or 1/aT_{lag}), the phase-lag compensator cannot provide the signal with a sufficient gain unless the phase-lag compensator has a new corner frequency higher 1/T_{newlag} than the corner frequency 1/T_{lag}. Such a phase-lag compensator of the new corner frequency 1/T_{newlag} has a bandwidth probably overlapping with that of the phase-lead compensator.

Please refer to FIG. 3, which is a function block diagram of a focus & track servo system 10 of a CD drive according to the prior art. The system 10 comprises a pickuphead 12, a pre-amplifier 14 electrically connected to the pickuphead 12, a compensator circuit 16 electrically connected to the pre-amplifier 14, and an actuator & lens module 18 electrically connected to the compensator circuit 16 and pickuphead 12.

The pickuphead 12 receives a focus error signal from a compact disc 11 placed on the CD drive and transfers the focus error signal as well as a lens position signal from the actuator & lens module 18 to the pre-amplifier 14 for amplification. The pre-amplifier 14 transfers an error signal, which includes the amplified signal from the preamplifier 14 as well as a rotating frequency error signal due to a wobble structure and eccentric effect of the compact disc, to the compensator circuit 16 for compensation. The compensator circuit 16 compensates a gain and phase of the error signal and transfers the compensated error signal to the actuator & lens module 18. In correspondence to the compensated error signal, the actuator & lens module 18 generates the lens position signal and controls the motor of the CD drive to operate smoothly.

A focus & track servo system, as described previously, usually comprises a phase-lead compensator and a phase-lag compensator. Please refer to FIG. 4, which is a function block diagram of the compensator circuit 16 according to the prior art. The compensator circuit 16 comprises a phase-lead compensator 32 and a phase-lag compensator 34 connected in series with the phase-lead compensator 32. The error signal enters into the phase-lead compensator 32 and then the phase-lag compensator 34 sequentially. Please refer to FIG. 5, which is another function block diagram of the compensator circuit 16 according to the prior art. The compensator circuit 16 comprises a phase-lead compensator 42, a phase-lag compensator 44 connected in parallel with the phase-lead compensator 42, and an adder 46 electrically connected to the phase-lead compensator 42 and phase-lag compensator 44. The error signal travels through the phase-lead compensator 42 and phase-lag compensator 44 simultaneously. The adder 46 adds signals transferred from the phase-lead compensator 42 and phase-lag compensator 44 and outputs the compensated error signal. The phase-lead compensator 32, 42 of the compensator circuit 16 can be a high-pass filter, such as a differentiator, for stabilizing the system 10 while the phase-lag compensator 34, 44 can be an integrated circuit for reducing the steady-state error of the system 10.

When the CD drive has the motor run at a low speed, the phase-lag compensator 34, 44 of the compensator circuit 16 is still capable of providing a gain of a value large enough to compensate the rotating frequency error signal and does not affect the phase compensation provided by the phase-lead compensator 32, 42 for the system 10. The phase-lag compensator 34, 44 indeed makes a contribution to the stability of the system 10 while the CD drive is operating at a low speed. As the motor of the CD drive rotates faster and faster and the rotating frequency error signal of the error signal will have a higher frequency accordingly, since the rotating frequency error signal has a low frequency in contrast to a working frequency of the system 10 and is therefore processed by the phase-lag compensator 34, 44, so the phase-lag compensator 34, 44 cannot compensate the rotating frequency error signal effectively without increasing the bandwidth. However, an increase of the bandwidth of the phase-lag compensator 34, 44 due to the increase of the rotating frequency error signal not only results in a reduction of the declining rate of gain, it also overlaps with the bandwidth of the phase-lead compensator 42, 44. As a result, the system 10 is unstable due to an insufficiency of phase margin.

### SUMMARY OF INVENTION

It is therefore a primary objective of the claimed invention to provide a compensator circuit to overcome the drawback of the prior art.

According to the claimed invention, the compensator circuit comprises a phase-lead compensator for receiving an error signal generated by an optical storage device and generating a phase-lead error signal, a band-pass filter connected in parallel with the lead compensator for magnifying a rotating frequency error signal and generating a filtered signal, and an adder for synthesizing the phase-lead error signal and the filtered signal so as to reduce a steady-state error of the error signal. The compensator circuit does not comprise any phase-lag compensator.

It is an advantage of the claimed invention that a compensator circuit comprising a phase-lead compensator and a band-pass filter has a small bulk and is capable of reducing the steady-state error of the error signal and of solving the problem of bandwidth-overlap, especially in high-speed optical storage device.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a Bode plot of a first-order phase-lead compensator according to the prior art.

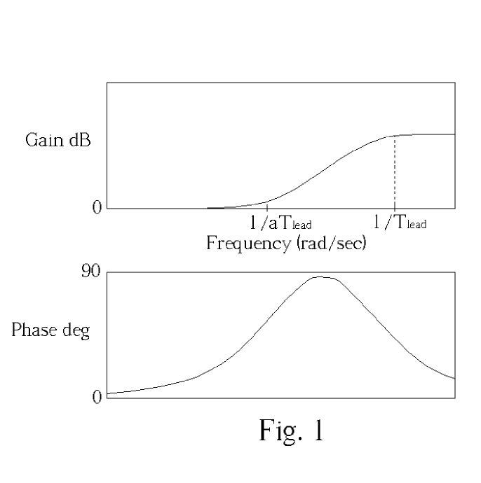

FIG. 2 is a Bode plot of a first-order phase-lag compensator according to the prior art.

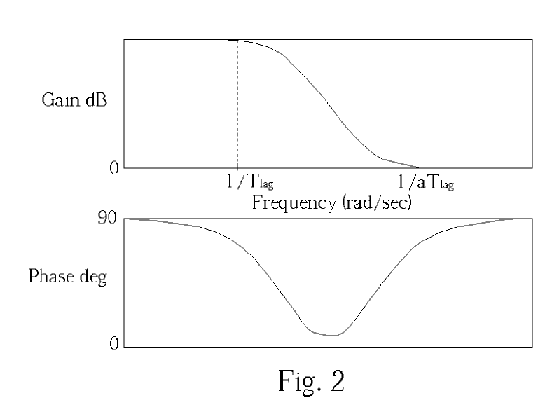

FIG. 3 is a function block diagram of a focus & track servo system of a CD drive according to the prior art.

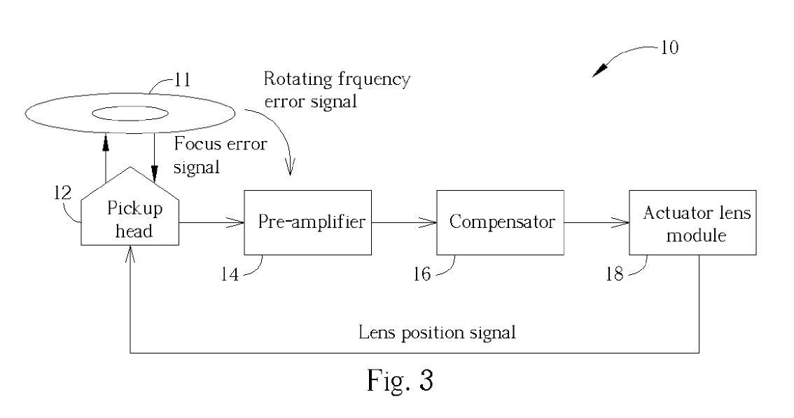

FIG. 4 is a function block diagram of a compensator of the focus & track servo system shown in FIG. 3 according to the prior art.

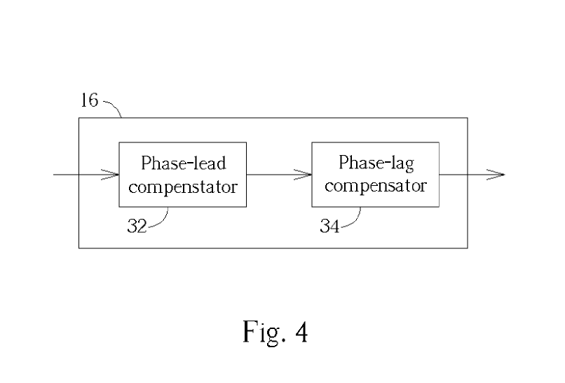

FIG. 5 is another function block diagram of the compensator of the focus & track servo system shown in FIG. 3 according to the prior art.

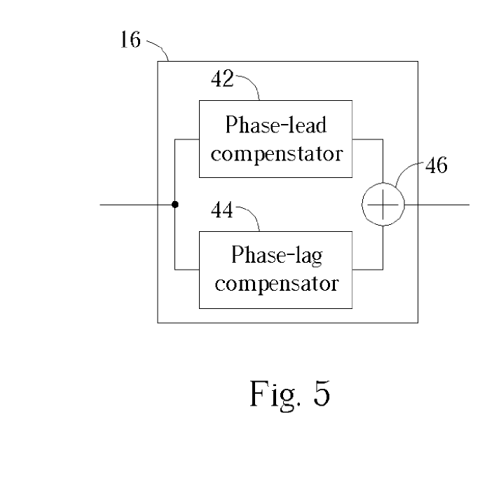

FIG. 6 is a function block diagram of a focus & track servo system of a CD drive according to the present invention.

FIG. 7 is a Bode plot of an open loop transfer function of the compensator circuit shown in FIG. 6 according to the present invention.

### DETAILED DESCRIPTION

The invention provides a device and related method for compensating an error signal produced by an optical storage device, such as a CD-ROM drive, a DVD-ROM drive, a CD-RW or a DVD-RW operating either on a constant angular velocity mode or on a constant linear velocity mode. The error signal comprises a focus error signal generated by a pickuphead due to the inaccuracy of laser emission and a rotating frequency error signal due to the wobble structure and corresponding eccentric effect of a compact disc.

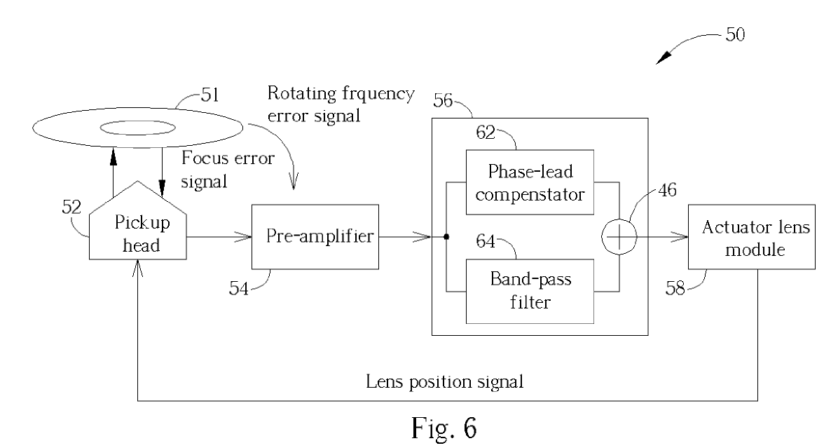

Please refer to FIG. 6, which is a function block diagram of a focus & track servo system 50 of a CD drive of the preferred embodiment of the present invention. The system 50 comprises a pickuphead 52, a pre-amplifier 54 electrically connected to the pickuphead 52, a compensator circuit 56 electrically connected to the pre-amplifier 54, and an actuator & lens module 58 electrically connected to the compensator circuit 56 and pickuphead 52. The system 50 has an operating process similar to that of the system 10, and a further description is hereby omitted.

In contrast to the compensator circuit 16 of the system 10, the compensator circuit 56 of the system 50 comprises a phase-lead compensator 62, a band-pass filter 64 connected in parallel with the phase-lead compensator 62, and an adder 66 connected to the phase-lead compensator 62 and the band-pass filter 64 for synthesizing signals output from the phase-lead compensator 62 and the band-pass filter 64. The phase-lead compensator 62 has a structure similar to that of the phase-lead compensator 32, 42. That is, the phase-lead compensator 62 can be also a high-pass filter, such as a differentiator. Please note that since a phase-lag compensator can only provide a low-frequency gain whose bandwidth overlaps with that of a phase-lead compensator while the CD drive is operating at a high speed, and a modern CD drive usually operates at the high speed, the compensator circuit 56 of the system 50 comprises the band-pass filter 64 instead of a phase-lag compensator.

The error signal input into the compensator circuit 56 enters into the phase-lead compensator 62 and band-pass filter 64 simultaneously. A filtered signal amplified by the band-pass filter 64 has a frequency close to that of a rotating frequency error signal produced by a motor of the CD drive in high-speed operation. In the preferred embodiment, since the band-pass filter 64 is capable of handling the rotating frequency error signal produced by the motor no matter how fast the speed the CD drive is operating at is, the CD drive can runs at a speed without a limit.

A phase-lead error signal output from the phase-lead compensator 62 as well as the filtered signal output the band-pass filter 66 first enter into the adder 66 simultaneously for synthesizing and then travel through the actuator & lens module 58 for further uses. The actuator & lens module 58 generates the lens position signal to reduce the steady-state error according the signals output from the adder 66 of the compensator circuit 56

In the system 50, since the band-pass filter 64 is in charge with a compensation process of the rotating frequency error signal of the error signal, the phase-lead compensator 62 can therefore concentrate on designing the bandwidth, without worrying that the bandwidth will be overlapped with the bandwidth of the band-pass filter 64. Even operating on too high a speed, the CD drive is still capable of reducing the steady-state signal.

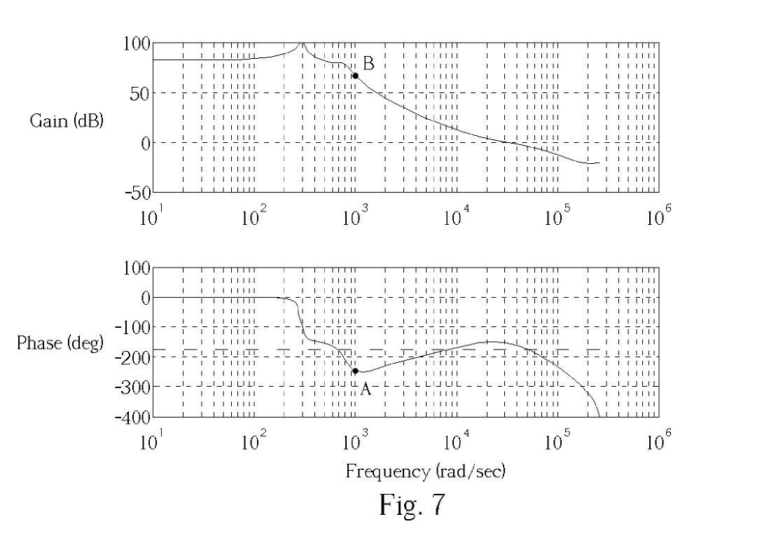

Please refer to FIG. 7, which is a Bode plot of an open loop transfer function of the compensator circuit 56 according to the present invention. A point A indicates a rotating frequency of the system 50, while a point B indicates a magnification rate in dB of the system 50. While operating on the rotating frequency, the system 50 has a magnification rate as high as 60 dB. The system 50 has a tolerable phase while operating in median frequency.

In addition to a device, the CD drive installed with the focus & track servo system 50, the present invention also presents a method capable of compensating an error signal produced by an optical storage device. The method comprises following steps:

Step 102: generating a phase-lead error signal according to the error signal with a phase-lead compensator;
Step 104: generating a filtered signal according to the error signal with a band-pass filter; and

Step 106: synthesizing the phase-lead error signal and the filtered signal with an adder so as to reduce a steady state error of the error signal.

Please note that the method does not comprise any step of generating a phase-lag error signal with a phase-lag compensator.

In contrast to the prior art, the present invention can provide a compensator circuit comprising a phase-lead compensator and a band-pass filter to process a rotating frequency error signal of an error signal produced by a CD drive in high-speed operation. The compensator circuit of the present invention has at least following advantages:
1. effectively reducing a steady-state error of CD drive with a simplified structure of a phase-lead compensator and a band-pass filter no matter how fast a speed the CD drive is operating at is; and
2. diminishing the problem of bandwidth-overlap of a phase-lead compensator and a phase-lag compensator by substituting a band-pass filter for a phase-lag compensator.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

1. A compensator circuit for compensating an error signal generated by an optical storage device, the compensator circuit comprising:
a phase-lead compensator for receiving the error signal and generating a phase-lead error signal;
a band-pass filter connected in parallel with the lead compensator for magnifying a rotating frequency error signal and generating a filtered signal; and
an adder for adding the phase-lead error signal and the filtered signal so as to lower a steady state error of the error signal;
the compensator circuit not comprising any phase-lag compensator.

2. The compensator circuit of claim 1, wherein the phase-lead compensator is a differentiator.

3. The compensator circuit of claim 1 is installed inside an optical storage device.

4. The compensator circuit of claim 3, wherein the optical storage device is a DVD-ROM drive.

5. The compensator circuit of claim 3, wherein the optical storage device is a CD-ROM drive.

6. The compensator circuit of claim 3, wherein the optical storage device is a CD-RW drive.

7. The compensator circuit of claim 3, wherein the optical storage device is a DVD-RW drive.

8. The compensator circuit of claim 3, wherein the optical storage device further comprises a pickuphead.

9. A method for compensating an error signal generated by an optical storage device, the method comprising:
generating a phase-lead error signal according to the error signal with a phase-lead compensator;
generating a filtered signal according to the error signal with a band-pass filter; and
adding the phase-lead error signal and the filtered signal with an adder to lower a steady state error of the error signal;
the method not comprising the step of generating a phase-lag error signal with a phase-lag compensator.

10. The method of claim 9, wherein the phase-lead compensator is a differentiator.
